(19) United States
(12) Patent Application Publication
(10) Pub. No.: US 2026/0140702 A1
(43) Pub. Date: May 21, 2026

(54) EVENT-DRIVEN SEMANTIC APPROACH TO MODELLING COMPLEX DYNAMIC PROCESSES

(71) Applicants: Artur PAKHOMOV, Pyrgos (CY); Aleksand BOLDACHEV, Larnaca (CY); SINTUR HOLDINGS LIMITED, Limassol (CY)

(72) Inventor: Aleksandr BOLDACHEV, Larnaca (CY)

(21) Appl. No.: 18/951,969

(22) Filed: Nov. 19, 2024

(51) Int. Cl. G06F 8/10; G06F 8/34; G06F 8/41

(52) U.S. Cl. CPC G06F 8/10; G06F 8/34; G06F 8/433; G06F 8/436

(57) ABSTRACT

A subject-event method and a workflow engine developed based on it are designed for no-code creation and execution of semantic models of business processes and construction of domain ontologies. The operation of the workflow engine is based on original event semantics using the semantic implementation of a dataflow approach to algorithm execution. The use of a unified event data format made it possible to implement: (1) a specification for describing actions and entities, (2) a semantic workflow engine for executing business processes, (3) a semantic temporal data store. The invention provides a unified platform for enterprise content management, process automation, and knowledge base maintenance, addressing the limitations of traditional workflow engines and semantic technologies.

### TECHNICAL FIELD

The present invention relates to the field of information technology systems, and more particularly relates to semantic technologies and knowledge representation systems, Business Process Management (BPM) systems and workflow engines, dataflow architecture, and no-code development platforms for business process automation. More particularly, embodiments of the invention involve, for example, contract lifecycle management and document automation, Knowledge bases (KG), Customer Relationship Management (CRM), Project Management (PM), Internet of Things (IoT) data collection and analysis.

### BACKGROUND OF THE INVENTION

Modern enterprises increasingly rely on information technology systems to manage their business processes, maintain corporate knowledge, and facilitate document flow. These systems typically comprise multiple specialized solutions: BPM systems, workflow engines, document management systems, and knowledge bases. However, the integration and maintenance of these separate systems present significant challenges.

Current BPM systems and workflow engines, while effective for modeling and executing predefined business processes, often lack flexibility in real-time process modification and face difficulties in handling complex, distributed processes. Traditional workflow engines typically employ control flow architecture, which can limit parallel processing capabilities and complicate process scaling.

Existing semantic technologies and knowledge representation systems primarily focus on static data relationships, struggling to effectively capture and represent the temporal and causal aspects of business processes. This limitation makes it challenging to maintain complete historical records of process execution and analyze process evolution over time.

The field of no-code development platforms for business process automation, while growing rapidly, currently lacks solutions that can seamlessly combine process modeling, execution, and knowledge management. Most platforms require significant programming expertise for complex process implementation and modification.

Furthermore, current enterprise systems often struggle with: maintaining semantic consistency across different business domains; preserving complete historical records of process execution; providing flexible process modeling capabilities for non-technical users; enabling real-time process modifications without system interruption.

These challenges indicate a need for an integrated approach that combines semantic modeling, process execution, and knowledge management in a single, flexible system.

### SUMMARY OF THE INVENTION

This summary is provided to introduce a selection of concepts in a simplified form that are further described below in the detailed description. This summary is not intended to identify key features of the present invention, nor is it intended to be used to limit the scope of the present invention.

It is an objective of the present invention to provide a flexible (in terms of changes) event-driven semantic approach to modelling complex dynamic processes (like business processes).

The objective above is achieved by the features of the independent claims in the appended claims. Further embodiments and examples are apparent from the dependent claims, the detailed description, and the accompanying drawings.

The present invention provides a method and apparatus for implementing a formal representation of any activity as a set of events generated and recorded by the actors of that activity (actors), where relationships between actors and resources are represented as event sequences recorded and generated by the actors.

The present invention implements a subject-event method and a workflow engine developed based on it, designed for no-code creation and execution of semantic models of business processes and construction of domain ontologies. The operation of the workflow engine is based on an original event semantics utilizing a semantic implementation of the dataflow approach to algorithm execution.

The apparatus includes a workflow engine that represents objects and business processes as directed acyclic graphs of events, capturing both semantic data content and causal relationships.

The workflow engine interprets executable semantic models describing sets of events and conditions for their execution, utilizing a unified event data format that enables: (1) specification for describing actions and objects, (2) semantic workflow execution, and (3) semantic temporal data storage.

In accordance with the invention, business logic modeling is implemented through executable semantic models utilizing a dataflow execution paradigm. The invention provides a method where business processes are modeled as sets of causally linked model events that generate reification events upon execution.

Use of the dataflow architecture makes it possible to modify the existing activity model and introduce new acts thereinto without stopping the execution of the entire activity (e.g., a business process can continue in a non-stop manner).

According to an aspect, a method is provided, which starts with the step of storing a set of events for an activity of interest. Each event from the set of events consists in recording a fact of the activity of interest that is associated with one of: creating an object, assigning or changing a property of the object, and performing an act with the object.

Each event from the set of events comprises: an event identifier; a semantic content of the event; an indication of an actor who or which performed the event; a reference to at least one other event from the set of events that conditions the event or sets an order in a sequence of events; a reference to a semantic model according to which the event was created; and a timestamp.

Events from the set of events are divided into: a subset of genesis events defining the primitives of an event ontology, property models, property vocabularies and restricting properties; a subset of model events combined into named models of objects and processes describing the activity of interest using the specified semantic primitives, vocabularies and values of restricting properties; a subset of reification events representing specific facts of the activity of interest, created according to the model events and values of restricting properties.

Then, the method proceeds to the step of receiving data from an actor about a fact of the activity of interest or by querying the subset of reification events to create a new reification event based on a target model from the subset of model events. The target model event indicates: an existing reification event to which the new reification event is to be assigned, and a type of the new reification event. The existing reification event is among the subset of reification events. The type of the new reification event is associated with a property or act whose value is assigned to an object in the new reification event.

Next, the method goes on to the step of verifying that for the new reification event created based on the target model event, conditions and constraints prescribed by the restricting properties of the target model event are fulfilled. The conditions and constraints include: constraints on the value of the property for the new reification event which include a permissible range, a data type and format, mutability, an allowable quantity; an access permission for the actor to perform the new reification event; and a feasibility condition of the target model event for creating new reification events. Feasibility conditions represented by a logical expression in which values of properties or acts for existing reification events are compared with predefined values and value of new reification event, ensuring the new event can only be created if the expression evaluates as true.

Then, if the initial creation attempt a new reification event fails due to unmet conditions, the method proceeds to the step of creating a subscription to monitor future reification events. If the new reification event and said at least one of the subsequent new reification events jointly fulfill the conditions and constraints prescribed by the restricting properties of the target model event, the next step is performed, in which the new reification event is created and the subscription is canceled;

Then, the method proceeds to the steps of adding, to the new reification event, a reference to at least one other event in the set, defining either a conditional dependency or a sequential order and adding, to the new reification event, a reference to a semantic model by which the new reification event was created.

Further, it is checked during the method whether the new reification event and at least one of the subsequent new reification events jointly fulfill the conditions and constraints prescribed by the restricting properties of the target model event. If the new reification event and said at least one of the subsequent new reification events jointly fulfill the conditions and constraints prescribed by the restricting properties of the target model event, the next step is performed, in which the new reification event is created and the subscription is canceled.

Finally, the method ends up with the step of recording the created new reification event in at least one memory during the activity of interest.

In one exemplary embodiment, the set of events is stored as a directed acyclic graph (DAG) comprising a set of vertices and a set of edges, with each vertex being connected by one of the edges. In this embodiment, each vertex corresponds to one event from the set of events, and each edge corresponds to a conditional relationship between the adjacent events. Using such a graph, a complete description of a desired object and/or a desired actor as a participant in the activity of interest may be easily and quickly obtained with a single query of the graph. In other words, the DAG allows one to capture the order of the events, their dependencies, and their connection to a certain process in the activity of interest.

In one exemplary embodiment, the value is obtained from the DAG by using a graph query language. This allows using data from the DAG to automatically create new reification events based on the target model event.

In one exemplary embodiment, the restricting properties of the target model event include an indication of at least one role of actors entitled to use the target model event to create the new reification event. In this embodiment, it is further determined if a role of the actor of the new reification event is among the at least one role of actors indicated in the restricting properties of the target model event and, if this is the case, the actor is given a grant to create the new reification event during the activity of interest. By using the role-based restriction, access to create new reification events based on the target model event may be controlled, which is necessary for the implementation of business processes.

In one exemplary embodiment, the data are received from the actor being one of a person, a robot, a sensor, and a software agent. For example, the apparatus comprises an administrative graphical interface (GUI) configured to receive the data about the new reification event inputted by the actor (in this case, a person) and provide this data to the at least one processor. Thus, the apparatus according to the first aspect may interact with actors, which increases its flexibility in use. Furthermore, the GUI allows users to create and edit the model events themselves, as well as generate queries to the DAG. The GUI ensures proper interaction with an end-user and adaptive data display. It should also be noted that the apparatus according to the first aspect does not require programming skills on the part of a user (business analyst), thanks to the use of a no-code models and objects editor.

In accordance with the invention, a text notation for event ontology description is provided. This notation offers a human-readable format that retains the formal semantic precision necessary for model execution. The notation enables direct representation of the event-based model through: parent-child relationships; explicit property declarations with associated constraints; conditional expressions for execution logic and value calculation rules as queries.

In one exemplary embodiment, the activity of interest is one of a business process, a customer relationship management process, a document management process, a messaging service, and a community management process. This further confirms the versatility of use of the apparatus according to the first aspect.

In different exemplary embodiments, it is possible to use deployment configurations ranging from single-server installations to distributed networks with multiple nodes, supporting: semantic-based network clustering; configurable consensus mechanisms; selective data replication. This technical implementation ensures scalability, reliability, and security while maintaining the semantic integrity and execution efficiency of the business processes.

According to one other aspect, a computer program product is provided. The computer program product comprises a non-transitory computer-readable storage medium that stores a computer code. Being executed by at least one processor, the computer code causes the at least one processor to perform the method according to the present invention.

Other features and advantages of the present invention will be apparent upon reading the following detailed description and reviewing the accompanying drawings.

### BRIEF DESCRIPTION OF DRAWINGS

The present invention is explained below with reference to the accompanying drawings in which:

FIG. 1 shows a schematic block diagram of an apparatus configured to implement the event-driven semantic approach to modeling complex dynamic processes according to one exemplary embodiment; and

FIG. 2 shows an example of using feasibility conditions to create a new event according to an event-driven dataflow ideology.

### DETAILED DESCRIPTION OF THE INVENTION

Various embodiments of the present invention are further described in more detail with reference to the accompanying drawings. However, the present invention can be embodied in many other forms and should not be construed as limited to any certain structure or function discussed in the following description. In contrast, these embodiments are provided to make the description of the present invention detailed and complete.

According to the detailed description, it will be apparent to the ones skilled in the art that the scope of the present invention encompasses any embodiment thereof, which is disclosed herein, irrespective of whether this embodiment is implemented independently or in concert with any other embodiment of the present invention. For example, the apparatus and method disclosed herein can be implemented in practice by using any numbers of the embodiments provided herein. Furthermore, it should be understood that any embodiment of the present invention can be implemented using one or more of the elements presented in the appended claims.

The exemplary embodiments disclosed herein relates to the subject-event approach to semantic modeling complex dynamic processes, such as business processes, customer relationship management processes, document management processes, messaging services, and community management processes. In general, the proposed approach may be described as follows: any activity may formally be represented as a set of events generated and recorded by participants of that activity (i.e., actors). It is asserted that any content of such an activity may be expressed as an ordered system of events that captures relationships between the actors and between the actors and resources, i.e., as an event-based ontology. The event-based ontology may be considered as an activity model and, preferably, represented as a directed acyclic graph (DAG), where the DAG nodes are events, and the DAG edges are causal relationships between the events.

According to the exemplary embodiments disclosed herein, an actor may refer to the one who or which distinguishes, changes, acts. Formally, an actor is an authorized identifier. Through an authentication relationship, an actor may be associated with a human individual, as well as a robot, software agent, or sensor. Adding the actor to a semantic format of each event (discussed below) allows: (1) controlling the origin and validity of data, (2) obtaining a comprehensive description of actors as a set of events they generate, (3) including alternative opinions in the description of a subject area.

Furthermore, the apparatus according to the present invention implements a dataflow architecture for executing business logic, based on the principle of asynchronous data generation in which new data is created as soon as the results of previous operations become available. An event-based implementation of data flow architecture operates not with numeric or string values of calculations, but with semantically defined events that are generated given the presence or absence of a specified set of preceding events. Events that cause the execution of the next event are tracked through the subscription mechanism. This, on the one hand, simplifies the dataflow architecture and, on the other hand, corresponds to the natural understanding of a human activity, when each actor performs his/her own operation upon receiving all necessary resources. Adding a new model event will ensure the generation of new reification. events based on its conditional relationship with the previous model events and, in principle, will not affect the execution of the entire activity of interest.

In the exemplary embodiments disclosed herein, a model event represents a fundamental semantic unit that defines the structure and execution rules for business processes. Each model event specifies a property or action that may be performed by the actor, along with a comprehensive set of restrictions and conditions governing its execution. The model event structure supports both direct value assignment through actor input and automated value generation through queries and expressions that can reference other events in the semantic graph. The execution logic is implemented through condition expressions that determine when the event can be generated, while restricting properties control various aspects of event creation and validation. The model event serves as a template for generating reification events, ensuring that all business data conforms to defined semantic rules and process logic.

A special restriction of a model event can define conditions for executing the model event under consideration. Each feasibility condition may be defined by one or more logical expressions based on user-defined allowable values for the property associated with the model event under consideration and user-defined allowable values for the property associated with each its conditioning model event. Other restriction properties may be provided, namely: restrictions for the allowable values, such as the number of allowable values, a range of allowable values, an upper and/or lower limit(s) of allowable values, etc.

In accordance with the exemplary embodiments disclosed herein, a model represents an ordered collection of model events that comprehensively describes either an object structure or an action flow. Models serve as semantic templates for creating individuals and executing business processes, ensuring consistent application of business rules and data validation across the system.

According to the exemplary embodiments, each model maintains its own vocabulary of allowable properties, drawn from standardized semantic dictionaries. This ensures semantic consistency while enabling domain-specific customization. Models support dynamic modification during system operation. Particularly significant features of the models in the exemplary embodiments are their use for automatic generation of interfaces for creating objects and performing business processes.

In the exemplary embodiments disclosed herein, a reification event is an event to which a specific value of property is assigned in accordance with a particular model event. In other words, each model event may be considered as a template for corresponding reification events. Given this, the reification event must satisfy the feasibility condition (and restrictions, if any) for that model event which it is based on.

According to the exemplary embodiments disclosed herein, a role refers to the relationship of an actor and an organization, recording the actor's access rights to model events. Formally, each role is a list of rights granted to specific actors. In different organizations, one actor may have different roles.

According to the exemplary embodiments disclosed herein, the apparatus comprises the following set of components:

Dictionary Editor provides tools for managing semantic properties and their organization into thematic dictionaries. This component enables the creation of property instances through models, while supporting the configuration of global property restrictions such as domains, ranges, and data types. The editor manages the formation and modification of property dictionaries, including functionality for dictionary import and export operations.

Model Editor serves as the primary controller for creating and modifying semantic models. It supports the connection of property dictionaries to models, the addition of model events and nested properties, and manages property restrictions. The editor enables the configuration of access rights for both roles and specific actors, handles condition expressions for model event execution, and supports model composition through the embedding of existing models and their fragments.

Query and Expression Editor implements tools for constructing logical and mathematical expressions, as well as queries to the event graph. It provides both graphical and symbolic interfaces for query formation, supports variable substitution from the environment and current model context, and enables test execution of expressions within their intended context.

User Interface Controller implements the visualization and interaction layer of the system. It generates interface elements according to event models, and manages navigation between pages.

Execution Controller and Subscriptions operates on dataflow principles to process business logic encoded in condition expressions. It implements a subscription mechanism for monitoring required events, processes condition expressions when sufficient data becomes available, and either grants access permissions or generates new reification events based on the evaluation results.

Validator ensures the integrity of reification events through a plugin-based validation system. It verifies compliance with format requirements, checks event generation permissions, validates data types, and ensures adherence to all model-defined constraints and conditions.

System Controller processes system-level events through specialized plugins. It monitors the event graph for system events, retrieves necessary contextual data, and generates appropriate reification events using the system actor identity.

Semantic Store provides the persistent storage layer for events, maintaining the integrity of the event chain through cryptographic validation. It supports append-only operations, implements efficient query execution, and maintains specialized indexes based on models and common query patterns.

Authorization Controller manages system access and identity verification. It handles actor registration and authentication, supports role-based access control, and maintains user sessions across the system.

API module enables system integration through a standardized interface. It provides controlled access to the event graph and supports the creation of individuals and properties through models while enforcing appropriate access controls.

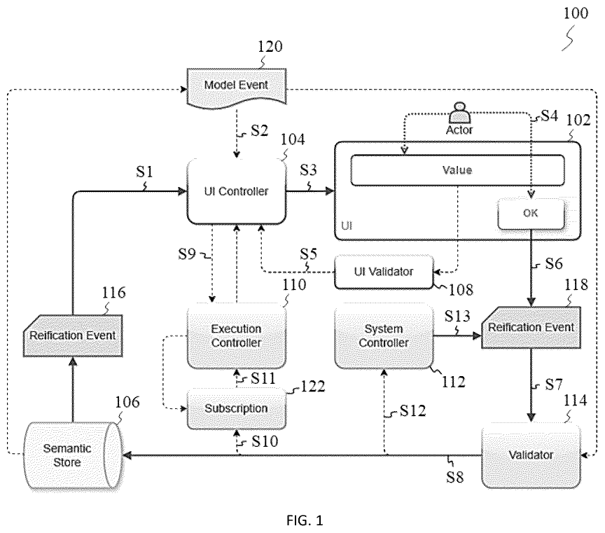

FIG. 1 schematically shows a schematic block diagram of an apparatus 100 configured to implement the subject-event approach to semantic modeling complex system processes according to one exemplary embodiment. The apparatus 100 may be implemented as an individual user device or equipment (UE) or as part thereof. The UE may refer to a mobile phone, a cellular phone, a smart phone, a cordless phone, a personal digital assistant (PDA), a wireless communication device, a laptop computer, a tablet computer, etc.

The apparatus 100 comprises the following constructive elements: a user interface 102 (e.g., GUI), a UI controller 104, a store 106, a UI validator 108, an execution controller 110, a system controller 112, and a system validator 114. It should be noted that these constructive elements may be implemented as software components, hardware components, or their combination. For example, in case of their hardware implementation, the constructive elements of the apparatus 100 (except for the store 106) may be implemented as one or more processors, where the processor(s) may refer to a CPU, general-purpose processor, single-purpose processor, microcontroller, microprocessor, application specific integrated circuit (ASIC), field programmable gate array (FPGA), digital signal processor (DSP), complex programmable logic device, of any combination thereof. As for the store 106, it may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

It should be noted that the apparatus 100 should not be necessarily arranged locally in a single user device—one or more of them may be distributed between the user device and a remote server. For example, a user may load the UI controller 104 via a browser installed on his/her user device (e.g., mobile phone), request event models for an activity of interest and send reification events via the UI 102 to the remote server based on these model events. Alternatively, all the components are loaded into the browser, and the activity of interest is implemented either locally or between different actors through a P2P network with data synchronization between nodes.

The operational principle of the apparatus 100 is as follows.

Step S1: The UI controller 104 requests an available (previously created) reification event 116 from the store 106 to display it in the UI 102.

Step S2: The UI controller 104 loads a corresponding model event 120 based on which the available reification event 116 was created.

Step S3: The UI controller 104 displays the reification event 116 taking into account all feasibility conditions and all constraints relating to the model event 120.

Step S4: The actor, if having a permission to create and edit a reification event (i.e., has a corresponding role), can change its value, and if there is no reification event corresponding to the model event 120, can create a new reification event 118, by entering a target value.

Step S5: The UI validator 108 checks the entered target value for compliance with the conditions and constraints relating to the model event 120.

Step S6: If the results of said check are positive (i.e., the target value satisfies the feasibility condition and the constraints), the new reification event 118 is created.

Step S7: The new reification event 118 is then checked by the system validator 114.

Step S8: The valid new reification event 118 is recorded in the store 106.

Step S9: The execution controller 110 checks the feasibility of the logical expression (condition); if the result is negative, a subscription 122 to a required (lacking) reification event is created in Step S10.

Step S11: The subscription 122 listens for new reification events created based on the model event 120.

Step S12: Upon the fulfillment of the logical expression, the execution controller 110 initiates the creation of the new reification event 118.

Step S13: The system controller 112 detects the appearance of a new system event (for example, notification events) and automatically generates new reification events.

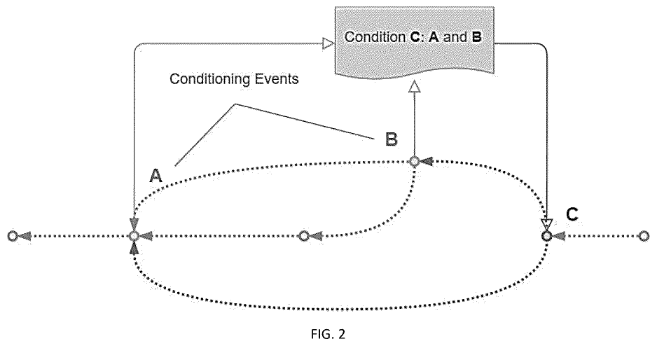

FIG. 2 shows an example of using conditions to create a new reification event according to a dataflow ideology. This figure demonstrates that reification event C can be created only if reification events A and B are present in the reification event graph. Thus, the connection of the new reification event with the previous ones goes from one to many, included in the logical expression (feasibility condition) of the model event which said logical expression is assigned to. In other words, not one reified event must correspond to the condition, but all included in the logical expression.

For example, if there is a logical (Boolean) expression “a>5 and b==100 and c!=0”, where a, b and c are the values of the previous reification events, then the new reification event for the model event, to which this logical expression is assigned, will be executed when all the previous reification events satisfy the sub-conditions of the logical expression. That is, the feasibility condition for the model event is the truth of the entire logical expression.

Let us now assume that the model event 120 is provided with the above-indicated logical expression “a>5 and b==100 and c!=0”. In this case, the execution controller 110 will check the values of the previous reification events a, b and c (which are loaded from the store 106 like the previous reification event 116). If all the reification events satisfy the specified conditions, then a permission to execute the model event 120 is issued to the actor via the UI 102, i.e., the new reification event 118 is allowed to be created based on it (the actor is allowed to enter the target value of the new reification event 118). However, if the values of the reification events a, b and c or at least one of them are not fulfilled (or there are no corresponding reification events yet in the store 106), then the subscription 122 is created by the execution controller 110 for such events, i.e., the apparatus 100 starts monitoring the occurrence of new reification events of this type. As soon as the reification events satisfying all three sub-conditions appear in the reification event graph, a permission to execute the new reification event 118 is issued, and the subscription 122 is deleted.

The target value for the property in the new reification event 118 may be entered by the actor in the special form field displayed in the UI 102 or retrieved by querying the graph. A query may return either the value of one of the existing events or the result of mathematical or logical operations performed on a set of model events (for example, return the sum of values, the maximum value, the number of events of a certain type, etc.). If the query returns a valid value (according to the data type and other restrictions), a new reification event is created (or several, if the query returns an array and this corresponds to the restrictions).

It should be noted that each of the above-mentioned steps or operations, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by one or more processors. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the exemplary embodiments of the present invention are described herein, it should be noted that any various changes and modifications could be made in the embodiments of the present invention, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. An event processing apparatus comprising:
at least one processor; and
at least one memory connected to the at least one processor and configured to store:
(i) a set of events describing an activity of interest, wherein each event in the set of events represents a fact associated with one of the following: creating an object, assigning or changing a property of the object, or performing an action with the object;
wherein each event in the set of events comprises:
an event identifier;
a semantic triplet comprising a basic event representing the event being described, a type representing a semantic type of the event, and a value representing a content or result of the event;
an indication of an actor who or which registered or performed the event;
a reference to at least one other event in the set of events, the at least one other event defining either a conditional dependency or sequential ordering;
a reference to a semantic model that the event complies with;
a timestamp indicating when the event was recorded or performed;
wherein the set of events is divided into:
a subset of genesis events defining semantic primitives of an event ontology, property models, property vocabularies and restricting properties;
a subset of model events combined into named models of objects and processes describing the activity of interest using the semantic primitives, the property vocabularies and values of the restricting properties;
a subset of reification events representing specific facts of the activity of interest and created according to the model events and the values of restricting properties; and
(ii) processor-executable instructions which, when executed by at least one processor, are configured to cause the at least one processor to:
receive data from an actor about a fact of the activity of interest, creating a new reification event based on a target model from the subset of model events, wherein the target model event specifies:
an existing reification event with which the new reification event is semantically associated;
a type of the new reification event corresponding to a property or action with a value assigned to an object;
obtain a value for the property or action for the object in the new reification event from the actor or by querying the subset of reification events;
create the new reification event based on the target model event with the obtained value;
validate the new reification event against semantic constraints defined in the target model event, including:
constraints on permissible ranges, data types, formats, mutability, and allowable quantities;
access permissions confirming that the actor is authorized to perform the event;
feasibility conditions represented by a logical expression in which values of properties or acts for existing reification events are compared with predefined values and the obtained value of the new reification event, ensuring the new reification event can only be created if the logical expression evaluates as true;
create a subscription to monitor future reification events if an initial attempt to create the new reification event fails due to the unmet conditions;
if the new reification event and said at least one of the subsequent new reification events jointly fulfill the
conditions and constraints prescribed by the restricting properties of the target model event, create the new reification event and cancel the subscription;
validate the new reification event together with subsequent reification events against the conditions in the restricting properties of the target model event;
add, to the new reification event, a reference to at least one other event in the set of events that defines either a conditional dependency or a sequential order;
add, to the new reification event, a reference to a semantic model by which the new reification event was created; and
record the created new reification event in the at least one memory during the activity of interest.

2. The apparatus of claim 1, wherein the at least one memory is configured to store the set of events as a directed acyclic graph comprising a set of vertices and a set of edges, and wherein each vertex from the set of vertices corresponds to one event from the set of events, and each edge from the set of edges corresponds to a conditional relationship between the adjacent events.

3. The apparatus of claim 1, wherein the at least one memory is configured to store the set of events as a semantic graph comprising a set of nodes and a set of edges, wherein each node from the set of nodes corresponds to one event from the set of events, and edges from the set of edges correspond to properties or relations connecting a base event with a literal or another reification event.

4. The apparatus of claim 1, wherein the at least one processor is caused to receive the data from the actor being one of a person, a robot, a sensor, and a software agent.

5. The apparatus of claim 1, wherein the activity of interest is one of a business process, a customer relationship management process, a document management process, a messaging service, and a voting process.

6. The apparatus of claim 1, wherein the restricting properties of the target model event include an indication of at least one role of actors entitled to use the target model event to create the new reification event, and the at least one processor is further caused to:
determine if a role of the actor of the new reification event is among the at least one role of actors indicated in the restricting properties of the target model event; and
If the role of the actor of the new reification event is among the at least one role of actors indicated in the restricting properties of the target model event, issue the actor a grant to create the new reification event during the activity of interest.

7. The apparatus of claim 1, wherein the semantic model includes a mechanism for semantic clustering of events based on their properties, enabling event grouping and efficient querying of event clusters.

8. The apparatus of claim 1, wherein the apparatus further comprises artificial intelligence (AI) or machine learning (ML) models configured to analyze historical event data to provide predictive insights or automate decision-making during event processing.

9. The apparatus of claim 1, wherein the apparatus supports dynamic modification of model events without interrupting system execution, allowing new model events to automatically subscribe to relevant reification events.

10. The apparatus of claim 1, wherein events in the set of events are cryptographically linked, ensuring data integrity and traceability.

11. An event processing method comprising:
storing a set of events describing an activity of interest, wherein each event represents creating, modifying, or executing an action on an object, each event including a semantic triplet, an actor, a dependency, a model identifier and a timestamp;
creating property instances and property vocabularies;
creating semantic models of objects and processes describing the activity of interest using the vocabularies and values of restricting properties;
creating a new reification event based on a target model event by receiving a value from an actor or by querying a subset of reification events;
validating the new reification event against semantic constraints defined in the target model event;
performing semantic validation of the new reification event using the vocabularies;
applying role-based access control by dynamically verifying a role of the actor against the restricting properties of the model event to confirm authorization for creating or modifying reification events;
supporting for dataflow processing for parallel and asynchronous event chains by creating a subscription;
maintaining a complete history of events to provide an audit trail, including archiving and retrieval mechanisms for historical data states;
ensuring free exchange of data between independent models thanks to a unified event format and use of standard dictionaries;
handling external data sources by integrating data from external actors, such as Internet of Things (IoT) devices, software agents, or external databases, into the event model, allowing for seamless expansion and interoperability with other systems;

12. A computer program product comprising a non-transitory computer-readable storage medium, wherein the non-transitory computer-readable storage medium stores a computer code which, when executed by at least one processor, causes the at least one processor to perform the method according to claim 11.
